(19) United States
(12) Patent Application Publication
(10) Pub. No.: US 2023/0319756 A1
(43) Pub. Date: Oct. 5, 2023

(54) DISASTER ROAMING FOR PLMN

(71) Applicant: Apple Inc., Cupertino, CA (US)

(72) Inventors: Roland GRUBER, Sauerlach (DE); Robert ZAUS, Munich (DE)

(21) Appl. No.: 18/190,255

(22) Filed: Mar. 27, 2023

Related U.S. Application Data
(60) Provisional application No. 63/325,138, filed on Mar. 29, 2022.

(51) Int. Cl. H04W 60/04; H04W 8/12; H04W 48/16

(52) U.S. Cl. CPC H04W 60/04; H04W 8/12; H04W 48/16; H04W 84/042

(57) ABSTRACT

A user equipment (UE) is configured to receive broadcast information from a cell of a public land mobile network (PLMN) including a parameter indicating support for disaster roaming, wherein the PLMN is a forbidden PLMN (FPLMN) for the UE, attempt a registration with the FPLMN by sending a registration request to the PLMN including a PLMN ID of a determined PLMN under disaster, receive a message including a cause code indicating the disaster roaming for the FPLMN is not allowed in a current tracking area (TA) of the cell for the determined PLMN under disaster, store a tracking area identifier (TAI) of the cell and prevent further registration attempts with the FPLMN for the determined PLMN under disaster when the UE is in the current TA.

### PRIORITY/INCORPORATION BY REFERENCE

This application claims priority to U.S. Provisional Application 63/325,138 filed on Mar. 29, 2022 entitled “Disaster Roaming for PLMN,” the entirety of which is incorporated herein by reference.

### BACKGROUND

A user equipment (UE) may establish a connection to at least one of multiple different networks or types of networks. The different networks, or network types, may provide different network services to the UE. For example, a base station of a network can provide the UE access to a public land mobile network (PLMN), e.g., a PLMN operating a 5G New Radio (NR) radio access network (RAN).

In some scenarios, the RAN of a PLMN is out of operation, e.g., due to a disaster condition. In these scenarios, another PLMN, which is normally a forbidden PLMN (FPLMN) for the UE, can enable disaster roaming for the UE. The FPLMN can provide normal services to the subscribers who are typically served by the PLMN under disaster.

### SUMMARY

Some exemplary embodiments are related to a processor of a user equipment (UE) configured to perform operations. The operations include receiving broadcast information from a cell of a public land mobile network (PLMN) including a parameter indicating support for disaster roaming, wherein the PLMN is a forbidden PLMN (FPLMN) for the UE, attempting a registration with the FPLMN by sending a registration request to the PLMN including a PLMN ID of a determined PLMN under disaster, receiving a message including a cause code indicating the disaster roaming for the FPLMN is not allowed in a current tracking area (TA) of the cell for the determined PLMN under disaster storing a tracking area identifier (TAI) of the cell and preventing further registration attempts with the FPLMN for the determined PLMN under disaster when the UE is in the current TA.

Other exemplary embodiments are related to a user equipment (UE) having a transceiver configured to communicate with one or more networks and a processor communicatively coupled to the transceiver and configured to perform operations. The operations include receiving broadcast information from a cell of a public land mobile network (PLMN) including a parameter indicating support for disaster roaming, wherein the PLMN is a forbidden PLMN (FPLMN) for the UE, attempting a registration with the FPLMN by sending a registration request to the PLMN including a PLMN ID of a determined PLMN under disaster, receiving a message including a cause code indicating the disaster roaming for the FPLMN is not allowed in a current tracking area (TA) of the cell for the determined PLMN under disaster, storing a tracking area identifier (TAI) of the cell and preventing further registration attempts with the FPLMN for the determined PLMN under disaster when the UE is in the current TA.

Still further exemplary embodiments are related to a processor of a base station configured to perform operations. The operations include transmitting broadcast information of a public land mobile network (PLMN) including a parameter indicating support for disaster roaming, receiving a registration request from a user equipment (UE) including a PLMN ID of a determined PLMN under disaster, wherein the PLMN is a forbidden PLMN (FPLMN) for the UE, determining that the determined PLMN under disaster does not provide coverage in a current tracking area (TA) and transmitting a message including a cause code indicating the disaster roaming is not allowed by the FPLMN in the current TA for the determined PLMN under disaster.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4a shows a table illustrating an exemplary network deployment for a UE in which one or more PLMNs are out of operation, e.g., under a disaster condition, in the current UE geographical area according to various exemplary embodiments.

FIG. 4b shows an exemplary diagram for UE and network operations performed in the scenario described in FIG. 4a when only the disaster-related indication, and no list of PLMNs under disaster, is broadcasted by the PLMNs offering disaster roaming according to various exemplary embodiments.

FIG. 4c shows an exemplary diagram for UE and network operations performed in the scenario described in FIG. 4a when the disaster-related indication and an accompanying list of PLMNs under disaster in the TA is broadcast by the PLMNs offering disaster roaming in the TA according to various exemplary embodiments.

FIG. 5a shows a table 500 illustrating an exemplary network deployment for a UE in which one or more PLMNs are out of operation, e.g., under a disaster condition, in the current UE geographical area according to various exemplary embodiments.

FIG. 5b shows an exemplary diagram for UE and network operations performed in the scenario described in FIG. 5a when only the disaster-related indication, and no list of PLMNs under disaster, is broadcasted by the PLMNs offering disaster roaming according to various exemplary embodiments.

FIG. 5c shows an exemplary diagram for UE and network operations performed in the scenario described in FIG. 5a when the disaster-related indication and an accompanying list of PLMNs under disaster in the TA is broadcast by the PLMNs offering disaster roaming in the TA according to various exemplary embodiments.

FIG. 6 shows an exemplary method for PLMN selection in a disaster roaming scenario according to various exemplary embodiments described herein.

### DETAILED DESCRIPTION

The exemplary embodiments may be further understood with reference to the following description and the related appended drawings, wherein like elements are provided with the same reference numerals. The exemplary embodiments are described with regard to a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate electronic component. The exemplary embodiments are also described with regard to a 5G New Radio (NR) network. However, reference to a 5G NR network is merely provided for illustrative purposes. The exemplary embodiments may be utilized with any network that may establish a connection to a UE and exchange information and data with the UE.

The exemplary embodiments are described with regard to a system, device and method for a public land mobile network (PLMN) providing disaster roaming services and a user equipment (UE) attempting to access these disaster roaming services. In particular, the embodiments described herein relate to operations for rejecting a disaster roaming registration request of a UE using a new cause code indicating that disaster roaming is not allowed within a current tracking area of the UE when a second PLMN indicated in the registration request as PLMN under disaster (or PLMN out of operation) does not provide coverage in the TA. Additionally, the UE can use this new cause code to avoid further attempts to access the disaster roaming services of the PLMN indicating the same second PLMN in the registration request as PLMN under disaster while located in the TA. When the UE exits the current TA, the UE may again attempt to register with the PLMN by indicating the same second PLMN as PLMN under disaster in the registration request.

In the following, the term “disaster condition” may refer to a scenario where a PLMN that typically provides normal service in a region is currently out-of-operation (OoO). The types of events causing such an OoO “disaster condition” may vary, and any reference herein to a “disaster condition” is not limited to any particular type of outage, but more generally refers to the network/PLMN being unable to provide services to the UE to which it may normally provide such services.

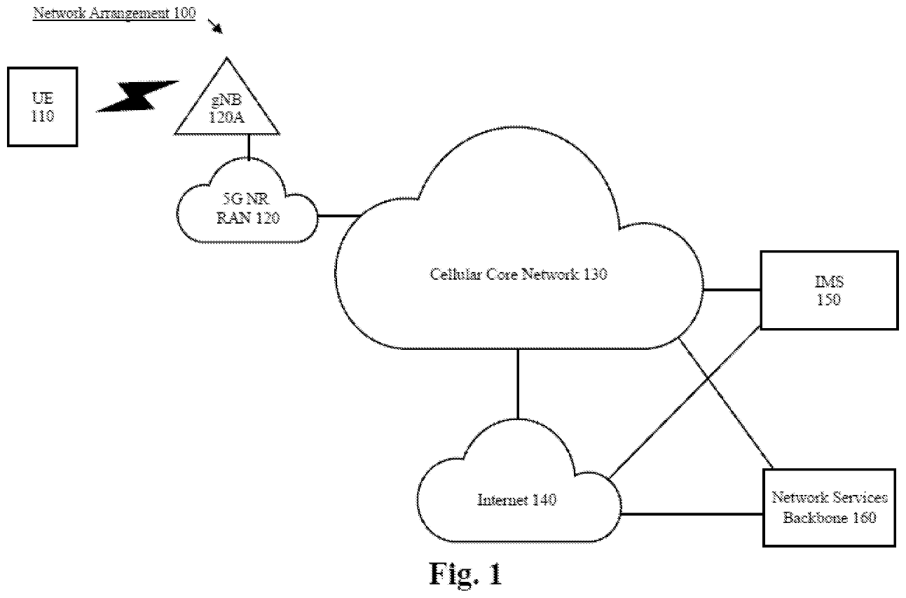

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network arrangement 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution RAN, a legacy cellular network, a WLAN, etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. The gNB 120A may include one or more communication interfaces to exchange data and/or information with UE 110, the corresponding RAN, the cellular core network 130, the internet 140, etc.

The UE 110 may connect to the 5G NR-RAN 120 via the gNB 120A. Those skilled in the art will understand that any association procedure may be performed for the UE 110 to connect to the 5G NR-RAN 120. For example, as discussed above, the 5G NR-RAN 120 may be associated with a particular cellular provider where the UE 110 and/or the user thereof has a contract and credential information (e.g., stored on a SIM card). Upon detecting the presence of the 5G NR-RAN 120, the UE 110 may transmit the corresponding credential information to associate with the 5G NR-RAN 120. More specifically, the UE 110 may associate with a specific cell (e.g., the gNB 120A). However, as mentioned above, reference to the 5G NR-RAN 120 is merely for illustrative purposes and any appropriate type of RAN may be used.

In addition to the 5G NR RAN 120, the network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

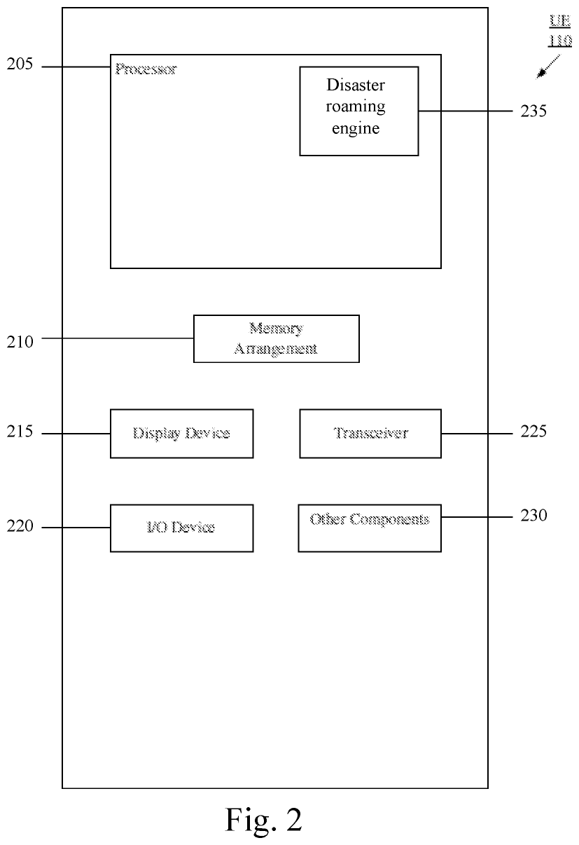

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a disaster roaming engine 235 configured to perform operations including determining an allowable PLMN for the UE that is currently under disaster and attempting to register with a forbidden PLMN (FPLMN) offering disaster roaming services using the allowable PLMN as the “determined PLMN.” The UE 110 may receive a rejection for the registration attempt including a new cause value indicating “Disaster roaming for the determined PLMN with disaster condition not allowed in this tracking area,” to be described in further detail below. When this new cause value is received, the disaster roaming engine 235 may store the tracking area identifier (TAI) of the cell to a list, to be described in greater detail below.

The above referenced engine being an application (e.g., a program) executed by the processor 205 is only exemplary. The functionality associated with the engine may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies).

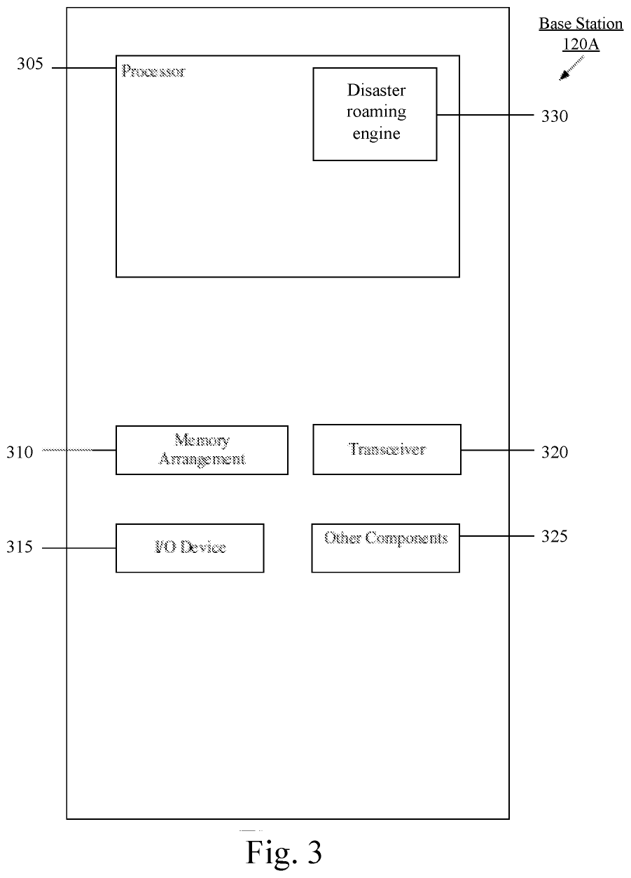

FIG. 3 shows an exemplary base station, e.g., gNB 120A, according to various exemplary embodiments. The gNB 120A may represent any access node through which the UE 110 may establish a connection and manage network operations.

The gNB 120A may include a processor 305, a memory arrangement 310, an input/output (I/O) device 315, a transceiver 320, and other components 325. The other components 325 may include, for example, a battery, a data acquisition device, ports to electrically connect the base station to other electronic devices, etc.

The processor 305 may be configured to execute a plurality of engines of the gNB 120A. For example, the processor 305 of the gNB 120A may execute a disaster roaming engine 330 that may cause the gNB 120A to perform operations including broadcasting information indicating disaster roaming services are supported, receiving a registration attempt from a UE indicating a “determined PLMN under disaster,” and rejecting the registration attempt using a new cause value indicating “Disaster roaming for the determined PLMN with disaster condition not allowed in this tracking area,” to be described in further detail below.

However, reference to a processor 305 is only exemplary. The functionality associated with the engines may also be represented as a separate incorporated component of the gNB 120A or may be a modular component coupled to the gNB 120A, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory arrangement 310 may be a hardware component configured to store data related to operations performed by the gNB 120A. The I/O device 315 may be a hardware component or ports that enable a user to interact with the gNB 120A. The transceiver 320 may be a hardware component configured to exchange data with the UE 110 and any other UE. The transceiver 320 may operate on a variety of different frequencies or channels (e.g., set of consecutive frequencies). Therefore, the transceiver 320 may include one or more components (e.g., radios) to enable the data exchange with the various networks and UEs.

A public land mobile network (PLMN) refers to the wireless services offered by a network operator to a subscriber in a particular geographical area. The network arrangement 100 described above may represent a network arrangement deployed by an operator of a particular public land mobile network (PLMN). In some scenarios, multiple PLMNs may operate within a same network arrangement 100 and share components, e.g., base stations. One PLMN can connect to other PLMNs for providing services including roaming, messaging, data, etc. These other PLMNs may belong to the same operator or a different operator. The exemplary embodiments described herein can relate to any number of network arrangements deployed by any number of PLMNs, as will be described in greater detail below.

Each PLMN is identified by a PLMN ID comprising a combination of a mobile country code (MCC) and a mobile network code (MNC), wherein each such combination is globally unique. The home PLMN (HPLMN) of a subscriber is stored on the SIM card of the subscriber. Additionally, one or more visited PLMNs (VPLMN) can be maintained by the UE and stored on the SIM. When the UE attempts to access a PLMN that is not a HPLMN, and is successful in its attempt, the accessed PLMN can be stored as a VPLMN. In other scenarios, VPLMNs can be stored at the UE in different ways. A forbidden PLMN (FPLMN) refers to a PLMN to which the UE cannot typically connect. A list of FPLMNs is maintained by the UE and stored on the SIM. A new PLMN entry is added to the list of FPLMNs when the UE attempts to access the PLMN (e.g., transmits an attach request) and the network rejects the request using a cause code of “PLMN not allowed.”

A UE may attempt to access a public land mobile network (PLMN), e.g., register with the network, when system information broadcast from the network is detected by the UE, including, e.g., a PLMN ID comprising a mobile country code (MCC) and a mobile network code (MNC). The UE may then initiate registration by transmitting a registration request to the PLMN, which can be accepted by the PLMN or rejected in association with a cause code for the rejection. When the UE is located in a geographical position in which, due to regulatory or legal restrictions, the network is not allowed to provide services, the PLMN may reject registration attempts from the UE. A cause code may be included in the registration rejection when the PLMN is not allowed to offer any services to the UE. The registration reject may be in response to an initial registration request, or a mobility registration request.

As described above, a UE may establish a connection to the respective RAN of one or more PLMNs. In some scenarios, the RAN of a PLMN is out of operation, e.g., due to a disaster condition. In these scenarios, another PLMN, which is normally a forbidden PLMN (FPLMN) for the UE, can enable disaster roaming for the UE. The FPLMN can provide normal services to the subscribers who are typically served by the PLMN under disaster. It is the responsibility of the operator of the FPLMN to determine whether disaster roaming services can be provided to the UE. For example, the FPLMN can check whether a disaster roaming agreement (DRA) exists between the FPLMN and the HPLMN of the UE, and additionally whether a DRA exists between the FPLMN and a PLMN indicated in the registration request (e.g., a “determined PLMN with disaster condition”), as will be described in greater detail below.

In order to attempt the registration for disaster roaming, the UE determines the highest priority PLMN to which the UE would normally register, and which is under disaster, and indicate this PLMN as “Determined PLMN with disaster condition” when requesting registration for disaster roaming. The PLMN indicated as the “Determined PLMN with disaster condition” may be referred to in the following description as the “determined PLMN.” The UE can determine one or more “determined PLMNs” based on information stored at the UE, e.g., a database of PLMNs to which the UE can attach.

A PLMN offering disaster roaming services can indicate support of disaster roaming in various manners. In a first example, the PLMN can broadcast a “list of one or more PLMN(s) with disaster condition for which disaster roaming is offered by the available PLMN” in any NG-RAN cell. In a second example, the PLMN can broadcast a “disaster related indication” without an explicit list of PLMN(s) under disaster for which disaster roaming is offered. This information may be broadcast by the PLMN(s) via a system information block (SIB). In some exemplary embodiments, the disaster-related indication may comprise a single bit.

With regard to the second example, it is not specified whether the UE determines the “Determined PLMN with disaster condition”. In a first option, the UE can determine the “Determined PLMN with disaster condition” based on information locally stored on the UE regarding which PLMNs are deployed in a country, e.g., by selecting a PLMN from the database where the UE has stored the operator names for all known PLMN IDs. In a second option, the UE does not make a determination and in consequence does not indicate a “Determined PLMN with disaster condition”.

Some exemplary embodiments relate to the first option, where the UE determines and indicates the “determined PLMN” when attempting to register with a FPLMN offering disaster roaming (DR). If a first PLMN (e.g., PLMN 1) does not provide coverage in all areas of a country and the UE is in a location outside the coverage area of PLMN 1, subscribers who would normally be served by this PLMN 1 (e.g., in locations within the coverage area of PLMN 1) should not receive services via a forbidden PLMN (e.g., FPLMN 1) offering disaster roaming, regardless of whether PLMN 1 is under disaster or not. This means that, if a subscriber or visitor of the PLMN 1 attempts to register for disaster roaming on FPLMN 1 offering disaster roaming via the first option above (because other PLMNs in this area are under disaster), in a geographical area where the PLMN 1 does not provide coverage, then the FPLMN 1 offering disaster roaming should reject the registration request.

With the currently agreed concept, disaster roaming services will be provided to the subscriber only if the FPLMN 1 has a disaster roaming agreement (DRA) with the Home PLMN (HPLMN) of the subscriber and if FPLMN 1 has a DRA with the “Determined PLMN with disaster condition”, i.e., with PLMN 1. If the UE is located in the country of the HPLMN, then the “Determined PLMN with disaster condition” can be the HPLMN.

Currently, reject causes are defined only for the scenarios where 1) the FPLMN offering disaster roaming does not have any disaster roaming agreement (DRA) with the Home PLMN (HPLMN) of the subscriber (cause: “PLMN not allowed”) and 2) the PLMN 2 offering disaster roaming does not have any DRA with the “Determined PLMN with disaster condition” which is different from the HPLMN (cause: “Disaster roaming for the determined PLMN with disaster condition not allowed”). The cause code “PLMN not allowed” may be referred to herein as “Cause 1” and the cause code “Disaster roaming for the determined PLMN with disaster condition not allowed” may be referred to herein as “Cause 2.” These causes may be numbered differently according to various specifications, and “Cause 1” and “Cause 2” are merely used for illustrative purposes.

For the first case, when the UE receives the Registration Reject message with the cause “PLMN not allowed” (Cause 1), the UE will not re-attempt registration for disaster roaming with the same FPLMN (e.g., FPLMN 1). For the second case, when the UE receives the Registration Reject message with the cause “Disaster roaming for the determined PLMN with disaster condition not allowed” (Cause 2), the UE will not re-attempt registration for disaster roaming with the same FPLMN (e.g., FPLMN 1) using the PLMN 1 as the “determined PLMN”. The UE may, however, attempt registration for disaster roaming with the same FPLMN (e.g., FPLMN 1) using a different PLMN (e.g., PLMN 2) as the “determined PLMN”. In both cases, the UE can attempt registration for disaster roaming with a different FPLMN (e.g., FPLMN 2) using PLMN 1 or a different PLMN (e.g., PLMN 2) as the “determined PLMN”.

However, as discussed above, a third case exists where the request for disaster roaming registration is rejected because the “Determined PLMN with disaster condition” determined by the UE and signaled to the FPLMN (e.g., FPLMN 1) does not have coverage in the current geographical area. This third case is not presently covered by a reject cause. For this case, the UE should not be prevented to attempt registration for disaster roaming with the same FPLMN (e.g., FPLMN 1) using the PLMN 1 as the “determined PLMN” if the UE moves to a geographical area where the PLMN 1 normally has coverage.

According to various exemplary embodiments described herein, a disaster roaming framework is described in which a new cause is used to indicate that disaster roaming is not supported in the current tracking area (TA) for the “determined PLMN under disaster”. This new cause may be referred to herein as “Disaster roaming for the determined PLMN with disaster condition not allowed in this tracking area” and may further be referred to as “Cause 3.” However, those skilled in the art will ascertain that the new cause can be worded in any appropriate manner to convey the above-described concept and can comprise any cause number.

If the network of the FPLMN (e.g., FPLMN 1) concludes that, for the “determined PLMN,” disaster roaming is not allowed in the current tracking area (TA) (if, e.g., the FPLMN 1 has a DRA with the “determined PLMN” and with the HPLMN of the UE, but the “determined PLMN” does not provide coverage in the TA), the network of the FPLMN shall reject the registration request for disaster roaming with the new reject cause “Disaster roaming for the determined PLMN with disaster condition not allowed in this tracking area” (Cause 3). If the UE is located in the country of the HPLMN, then the “Determined PLMN with disaster condition” can be the HPLMN.

In some exemplary embodiments, the UE, upon reception of the registration reject cause (Cause 3), stores the Tracking Area Identity (TAI) of the cell where the cause was received in a list of “forbidden TAIs for disaster roaming for a determined PLMN with disaster condition” in association with the PLMN ID of the FPLMN from which the Cause 3 was received. The UE shall not re-attempt registration for disaster roaming within this TA and for this FPLMN using the same “determined PLMN” if the (TAI, FPLMN ID) entry is included in the list. In some embodiments, the PLMN ID of the FPLMN from which the Cause 3 was received may be included in the TAI.

After receiving the rejection from the first FPLMN (e.g., FPLMN 1), the UE may start a new attempt for PLMN selection. The UE may not attempt to select a PLMN if the detected cell of this PLMN is in a TA of this PLMN which is stored in the list of “forbidden TAIs for disaster roaming for a determined PLMN with disaster condition”. This list may be erased, e.g., all entries may be removed, periodically or upon certain events such as switch-off of the UE or removal of the USIM.

If there are other PLMNs offering disaster roaming for which the UE has not attempted the registration for disaster roaming, the UE may attempt registration for disaster roaming using one of these PLMNs.

In some embodiments, the UE may store the TAI of the cell where the new reject cause (Cause 3) was received together with the PLMN ID of the “Determined PLMN with disaster condition” in a list of “forbidden TAIs for disaster roaming for a specific determined PLMN with disaster condition”. The UE may not re-attempt registration for disaster roaming within this tracking area and using the same “Determined PLMN with disaster condition” if the (TAI, determined PLMN ID) entry is included in the list. But if the UE, based on the information stored locally on the UE, can determine a different “Determined PLMN with disaster condition” it may re-attempt registration for disaster roaming within the tracking area and using the new “Determined PLMN with disaster condition”. Similar to above, this list may be erased, e.g., all entries may be removed, periodically or upon certain events such as switch-off of the UE or removal of the USIM.

In the following, two example network deployments for a UE will be described with respect to the disaster roaming framework described above to further exemplify the disaster roaming operations performed by the UE and the PLMN providing disaster roaming services (which is, in these embodiments, a FPLMN for the UE).

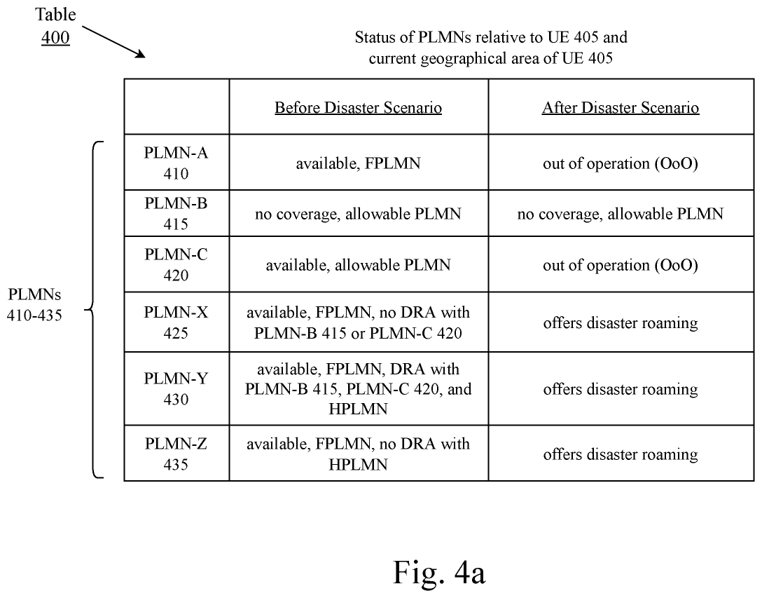

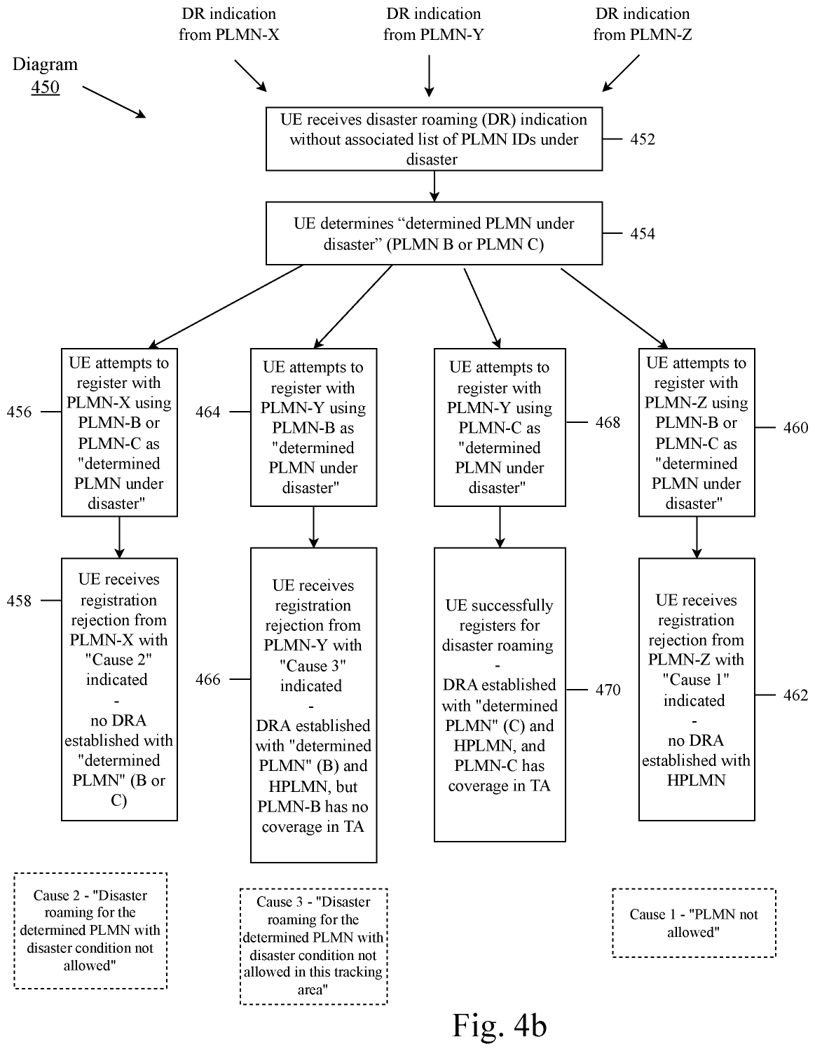

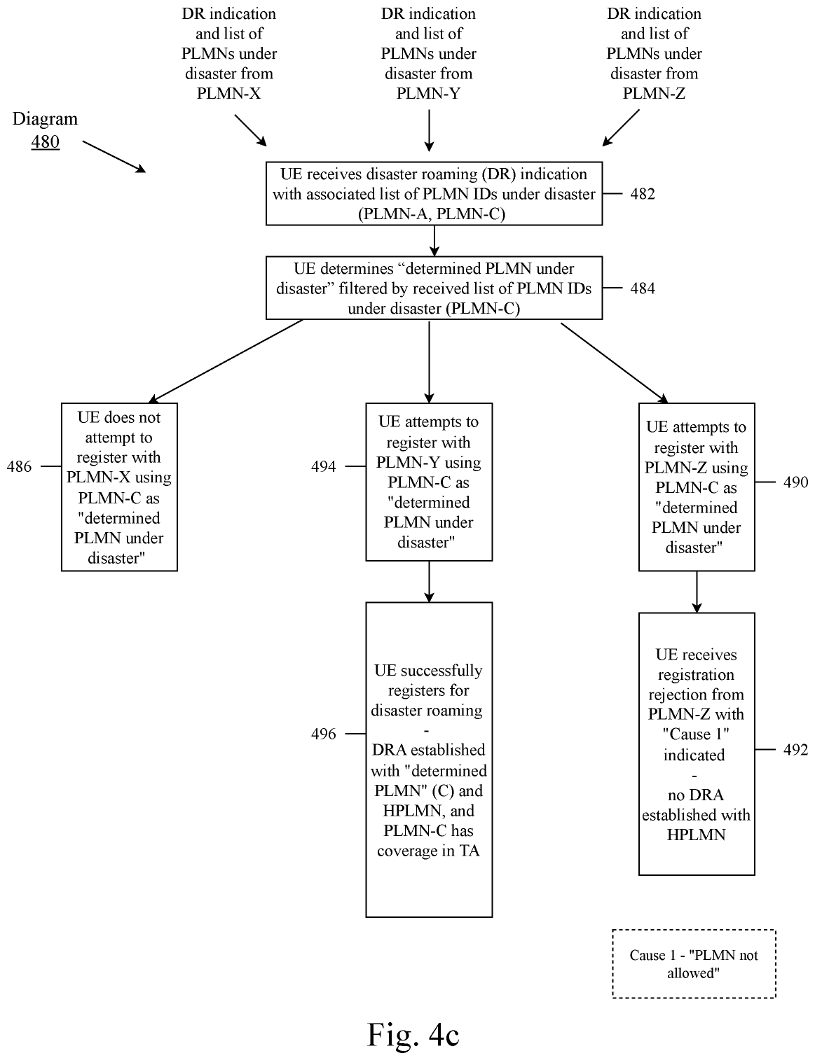

FIG. 4a shows a table 400 illustrating an exemplary network deployment for a user equipment (UE) 405 in which one or more PLMNs are out of operation, e.g., under a disaster condition, in the current UE geographical location according to a first example. In the table 400, six PLMNs are shown, e.g., a first PLMN (PLMN-A) 410, a second PLMN (PLMN-B) 415, a third PLMN (PLMN-C) 420, a fourth PLMN (PLMN-X) 425, a fifth PLMN (PLMN-Y) 430, and a sixth PLMN (PLMN-Z) 435. In this example, none of the six PLMNs 410-435 are the HPLMN for the UE 405.

The status of the PLMNs 410-435, relative to the UE 405 and the geographical location in which the UE 405 is located, are considered both before and after the occurrence of a disaster condition. Before the disaster scenario, PLMN-A 410 is available (e.g., has coverage) in the UE geographical location and is a FPLMN for the UE; PLMN-B 415 is not available (e.g., has no coverage) in the UE geographical location and is an allowable PLMN for the UE; PLMN-C 420 is available in the UE geographical location and is an allowable PLMN for the UE; PLMN-X 425 is available in the UE geographical location and is a FPLMN for the UE 405 without a disaster roaming agreement (DRA) with PLMN-B 415 or PLMN-C 420; PLMN-Y is available in the UE geographical location and is a FPLMN for the UE 405 with a DRA with both PLMN-B 415 and PLMN-C 420 and additionally with the HPLMN of the UE 405; PLMN-Z is available in the UE geographical location and is a FPLMN for the UE 405 without a DRA with the HPLMN of the UE 405.

After some disaster scenario, PLMN-A 410 is under the disaster condition in the UE geographical location; PLMN-B 415 remains unavailable (e.g., has no coverage) in the UE geographical location; PLMN-C 420 is under the disaster condition in the UE geographical location; and PLMN-X 425, PLMN-Y 430, and PLMN-Z 435 are available and offering disaster roaming. As described above, disaster roaming is offered by a PLMN to a UE only when a DRA exists with an allowable PLMN of the UE and with the HPLMN of the UE.

Given the aforementioned disaster scenario, the UE 405, the PLMN-X 425, the PLMN-Y 430, and the PLMN-Z 435 can perform communications in accordance with the following examples described with respect to the disaster roaming framework discussed above.

FIG. 4b shows an exemplary diagram 450 for UE and network operations performed in the scenario described in FIG. 4a when only the disaster-related indication, and no list of PLMNs under disaster, is broadcast by the PLMNs offering disaster roaming. As discussed above, the disaster-related indication can comprise a single bit in, for example, a SIB broadcast by the network.

In 452, the UE receives a disaster roaming indication from one or more of the PLMN-X 425, the PLMN-Y 430 or the PLMN-Z 435. In various examples, the UE may lose service with an allowable PLMN, e.g., PLMN-C 420, or be recently turned on and performing an initial cell selection. As described above, the PLMN selection procedure includes a series of steps that include decoding an SI broadcast carrying the disaster roaming indication from a cell of a PLMN.

In 454, the UE determines the highest priority PLMN to which the UE would normally register is under disaster, i.e., the “determined PLMN under disaster”. This determination is performed based on locally stored information at the UE. In the diagram 450, both PLMN-B and PLMN-C are separately considered as the “determined PLMN,” and corresponding operations are described for respective scenarios where the UE attempts to register with PLMN-X, PLMN-Y or PLMN-Z using PLMN-B or PLMN-C as the determined PLMN. Those skilled in the art would understand these operations can be performed in succession or independently according to the particular scenario encountered by the UE.

In a first scenario, in 456, the UE attempts to register with PLMN-X using either PLMN B or PLMN C as the determined PLMN. In either situation, in 458, PLMN-X rejects the registration request using cause 2 described above, where “Disaster roaming for the determined PLMN with disaster condition not allowed”. This cause is selected because no DRA exists between PLMN-X and either one of PLMN-B or PLMN-C.

In a second scenario, in 460, the UE attempts to register with PLMN-Z using either PLMN B or PLMN C as the determined PLMN. In either situation, in 462, PLMN-Z rejects the registration request using cause 1 described above, where “PLMN not allowed.” This cause is selected because no DRA exists between PLMN-Z and the HPLMN of the UE.

In a third scenario, in 464, the UE attempts to register with PLMN-Y using PLMN B as the determined PLMN. In 466, PLMN-Y rejects the registration request using new cause 3 described above, where “Disaster roaming for the determined PLMN with disaster condition not allowed in this tracking area.” This cause is selected because the DRA exists between PLMN Y and both the HPLMN of the UE and the determined PLMN, but the determined PLMN does not provide coverage in the TA of the cell. As described above, after receiving this new reject cause, the UE can attempt to register with PLMN-Y if the UE moves to a different tracking area.

In a fourth scenario, in 468, the UE attempts to register with PLMN Y using PLMN C as the determined PLMN. In 470, the UE successfully registers with PLMN Y for disaster roaming because the DRA is established with PLMN C and the HPLMN, and PLMN-C has coverage in current TA.

FIG. 4c shows an exemplary diagram 480 for UE and network operations performed in the scenario described in FIG. 4a when the disaster-related indication and an accompanying list of PLMNs under disaster in the TA is broadcast by the PLMNs offering disaster roaming in the TA. As discussed above, the disaster-related indication can comprise a single bit and the list of PLMNs can comprise PLMN IDs.

In 482, the UE receives a disaster roaming indication from one or more of the PLMNs 425-435 along with an accompanying list of PLMNs under disaster. Similar to 452 above, during the PLMN selection procedure, the UE may decode a SI broadcast carrying the disaster roaming indication and the accompanying list of PLMNs under disaster. In this example, the PLMN X lists PLMN-A in the accompanying list and the PLMNs Y and Z list PLMN-A and PLMN-C in the accompanying list. PLMN B is not listed because it has no coverage in the TA. PLMN-C is not listed by PLMN-X because no DRA exists with PLMN-X and PLMN-C.

In 484, the UE determines the highest priority PLMN to which the UE would normally register is under disaster, i.e., the “determined PLMN under disaster”, filtered by the list provided in the broadcast message. In the diagram 480, only PLMN-C is considered as the “determined PLMN” and corresponding operations are described for respective scenarios where the UE attempts to register with PLMN-Y or PLMN-Z using PLMN-C as the determined PLMN. Because PLMN B was not included in the list, the UE does not attempt to use PLMN B as the “determined PLMN”.

In a first scenario, in 486, the UE does not attempt to register with PLMN-X using PLMN A as the determined PLMN because PLMN A is a forbidden PLMN. The UE further does not attempt to register with PLMN-X using PLMN-C because the PLMN-ID of PLMN-C was not broadcast by PLMN-X.

In a second scenario, in 490, the UE attempts to register with PLMN-Z using PLMN C as the determined PLMN. In 492, PLMN-Z rejects the registration request using Cause 1.

In a third scenario, in 494, the UE attempts to register with PLMN-Y using PLMN C as the determined PLMN. In 496, the UE successfully registers with PLMN Y for disaster roaming. DRA established with PLMN C and HPLMN, and PLMN-C has coverage in current TA.

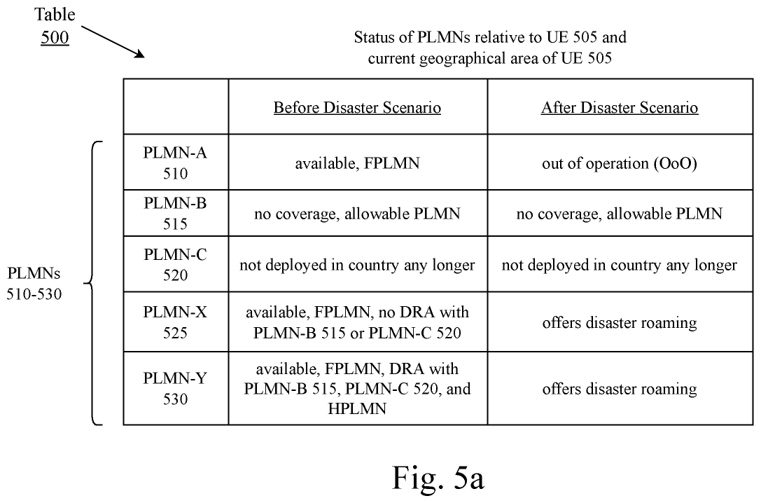

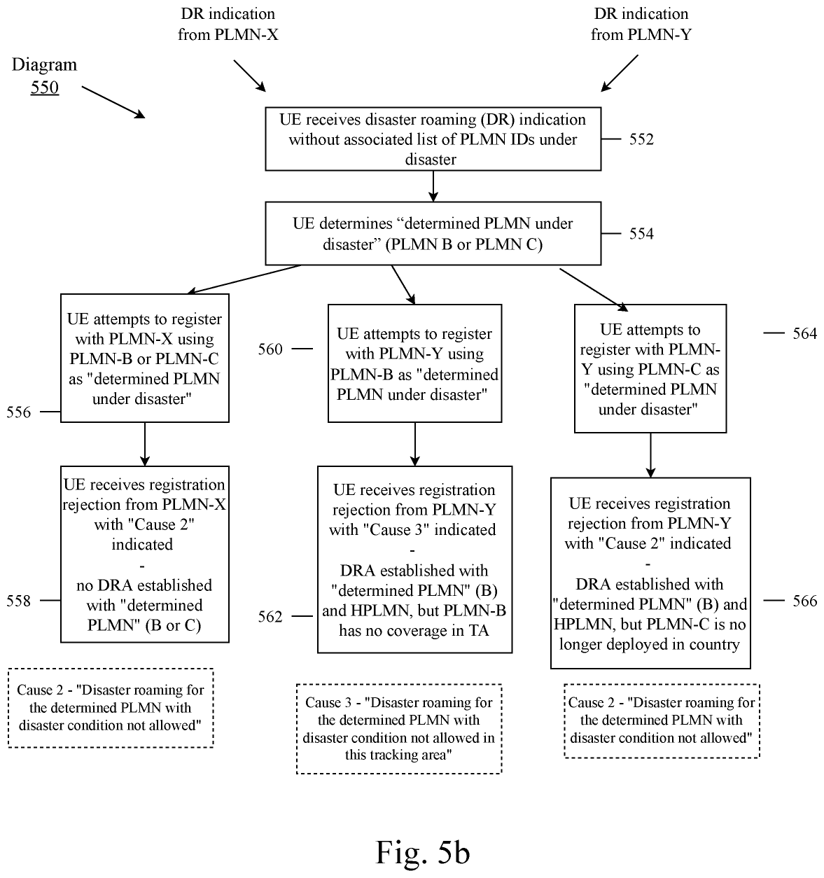

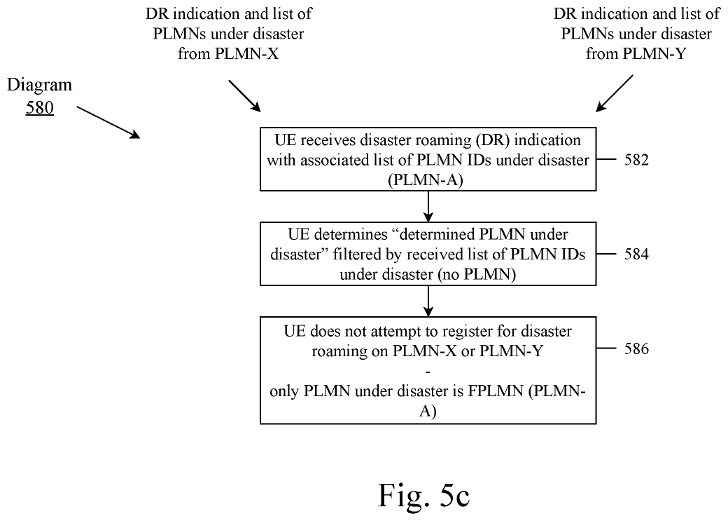

FIG. 5a shows a table 500 illustrating an exemplary network deployment for a user equipment (UE) 505 in which one or more PLMNs are out of operation, e.g., under a disaster condition, in the current UE geographical location according to a second example. In the table 500, five PLMNs are shown, e.g., a first PLMN (PLMN-A) 510, a second PLMN (PLMN-B) 515, a third PLMN (PLMN-C) 520, a fourth PLMN (PLMN-X) 525, and a fifth PLMN (PLMN-Y) 530. In this example, none of the five PLMNs 510-530 are the HPLMN for the UE 505.

The status of the PLMNs 510-530, relative to the UE 505 and the geographical location in which the UE 505 is located, are considered both before and after the occurrence of a disaster condition. Before the disaster scenario, PLMN-A 510 is available (e.g., has coverage) in the UE geographical location and is a FPLMN for the UE; PLMN-B 515 is not available (e.g., has no coverage) in the UE geographical location and is an allowable PLMN for the UE; PLMN-C 520 was previously deployed in the country and is not deployed in the country any longer; PLMN-X 525 is available in the UE geographical location and is a FPLMN for the UE 505 without a disaster roaming agreement (DRA) with PLMN-B 515 or PLMN-C 520; and PLMN-Y 530 is available in the UE geographical location and is a FPLMN for the UE 505 with a DRA with both PLMN-B 515 and PLMN-C 520 and additionally with the HPLMN of the UE 505.

After some disaster scenario, PLMN-A 510 is under the disaster condition in the UE geographical location; PLMN-B 515 remains unavailable (e.g., has no coverage) in the UE geographical location; PLMN-C 520 remains not deployed in the country any longer; and PLMN-X 525 and PLMN-Y 530 are available and offering disaster roaming. As described above, disaster roaming is offered by a PLMN to a UE only when a DRA exists with an allowable PLMN of the UE and with the HPLMN of the UE.

Given the aforementioned disaster scenario, the UE 505, the PLMN-X 525 and the PLMN-Y 530 can perform communications in accordance with the following examples described with respect to the disaster roaming framework discussed above.

FIG. 5b shows an exemplary diagram 550 for UE and network operations performed in the scenario described in FIG. 5a when only the disaster-related indication, and no list of PLMNs under disaster, is broadcasted by the PLMNs offering disaster roaming.

In 552, the UE receives a disaster roaming indication from one or more of the PLMN-X 525 and the PLMN-Y 530. In various examples, the UE may lose service with an allowable PLMN, or be recently turned on and performing an initial cell selection. As described above, the PLMN selection procedure includes a series of steps that include decoding an SI broadcast carrying the disaster roaming indication from a cell of a PLMN.

In 554, the UE determines the highest priority PLMN to which the UE would normally register is under disaster, i.e., the “determined PLMN under disaster”. This determination is performed based on locally stored information at the UE. In the diagram 550, both PLMN-B and PLMN-C are separately considered as the “determined PLMN,” and corresponding operations are described for respective scenarios where the UE attempts to register with PLMN-X or PLMN-Y using PLMN-B or PLMN-C as the determined PLMN. Those skilled in the art would understand these operations can be performed in succession or independently according to the particular scenario encountered by the UE.

In a first scenario, in 556, the UE attempts to register with PLMN-X using either PLMN B or PLMN C as the determined PLMN. In either situation, in 558, PLMN-X rejects the registration request using cause 2 described above, where “Disaster roaming for the determined PLMN with disaster condition not allowed”. This cause is selected because no DRA exists between PLMN-X and either one of PLMN-B or PLMN-C.

In a second scenario, in 560, the UE attempts to register with PLMN-Y using PLMN B as the determined PLMN. In 562, PLMN-Y rejects the registration request using cause 3 described above, where “Disaster roaming for the determined PLMN with disaster condition not allowed in this tracking area.” This cause is selected because the DRA exists between PLMN Y and both the HPLMN of the UE and the determined PLMN, but the determined PLMN does not provide coverage in the TA of the cell.

In a third scenario, in 564, the UE attempts to register with PLMN-Y using PLMN C as the determined PLMN. In 566, PLMN-Y rejects the registration request using cause 2 described above, where “Disaster roaming for the determined PLMN with disaster condition not allowed”. This cause is selected because PLMN C is no longer deployed in the country.

FIG. 5c shows an exemplary diagram 580 for UE and network operations performed in the scenario described in FIG. 5a when the disaster-related indication and an accompanying list of PLMNs under disaster in the TA is broadcast by the PLMNs offering disaster roaming in the TA. As discussed above, the disaster-related indication can comprise a single bit and the list of PLMNs can comprise PLMN IDs.

In 582, the UE receives a disaster roaming indication from one or more of the PLMNs X or Y along with an accompanying list of PLMNs under disaster. Similar to 552 above, during the PLMN selection procedure, the UE may decode SI broadcast carrying the disaster roaming indication and the accompanying list of PLMNs under disaster. In this example, the PLMNs X and Y list PLMN-A in the accompanying list. PLMN B is not listed because it has no coverage in the TA and PLMN C is not listed because it is no longer deployed in the country.

In 584, the UE determines the highest priority PLMN to which the UE would normally register is under disaster, i.e., the “determined PLMN under disaster”, filtered by the list provided in the broadcast message. In the diagram 580, no PLMN is determined as the “determined PLMN.” The PLMN A is a FPLMN for the UE, and it is only PLMN A that is included in the broadcasted list.

In 586, the UE does not attempt to register for disaster roaming on PLMN X or PLMN Y as the only PLMN under disaster is PLMN A (an FPLMN for the UE).

The present embodiments provide various UE and network advantages. The UE will gain knowledge of TAs in which a “determined PLMN” cannot be used, and avoid attempting to register with that “determined PLMN” in that same TA, but will not avoid attempting to register with the same FPLMN using the same “determined PLMN” when the UE changes to a different TA. The operator providing disaster roaming can indicate disaster roaming support with a single “Disaster related indication” without broadcasting an explicit list of PLMN under disaster, thus saving valuable bandwidth on the SI broadcast. The FPLMN that rejects the registration request in the particular TA can provide disaster roaming services to the UE once the UE enters a TA where the “determined PLMN under disaster” has coverage (under non-disaster conditions), and can generate revenue based on the provided disaster services.

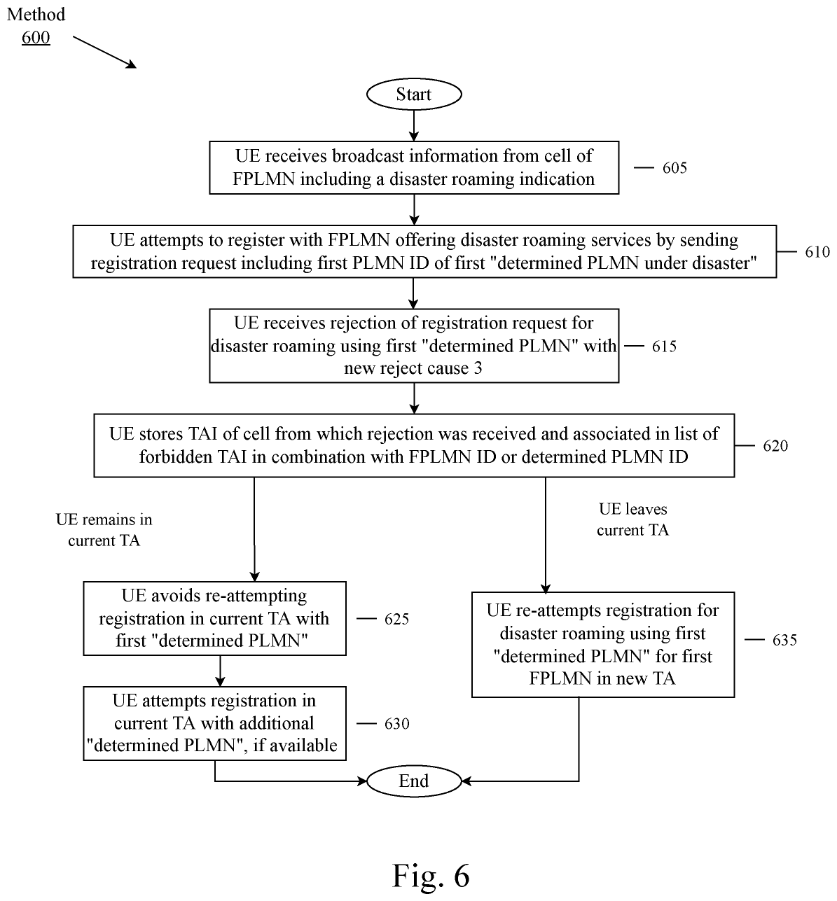

FIG. 6 shows an exemplary method 600 for PLMN selection in a disaster roaming scenario according to various exemplary embodiments described herein.

In 605, a user equipment (UE) receives broadcast information from a cell of a public land mobile network (PLMN), e.g., a forbidden PLMN (FPLMN), including at least a PLMN identifier (ID) and a disaster roaming (DR) indication. In this example, the UE does not receive any associated list of PLMN IDs under disaster. In other words, the PLMN broadcasts only the parameter indicating support for disaster roaming in the SI broadcast. As described above, in other embodiments, the PLMN may further broadcast the associated list of PLMN IDs under disaster, which can simplify the PLMN selection process for the UE. However, this embodiment is not considered in the exemplary method 600.

In 610, the UE attempts to register with the FPLMN offering disaster roaming services by sending a registration request to the FPLMN including a PLMN ID of a “determined PLMN under disaster”. The registration request may be an initial registration request, or may be a mobility registration request. The UE determines the “determined PLMN under disaster” based on information stored locally on the UE. For example, the information can comprise a database where the UE has stored the operator names for all known PLMN IDs. In some embodiments, the UE can determine more than one “determined PLMN” from this database. The “determined PLMN” can be the HPLMN for the UE or a VPLMN for the UE. In some embodiments, in the registration request, the UE may additionally includes its HPLMN ID so that the FPLMN can determine whether a disaster roaming agreement (DRA) exists between the FPLMN and the UE HPLMN. In some embodiments, the HPLMN ID may be included as part of the subscriber concealed identity (SUCI).

In 615, the UE receives a message from the cell of the FPLMN including a cause code indicating “Disaster roaming for the determined PLMN with disaster condition not allowed in this tracking area” (e.g., new Cause 3 described above). The message may be a registration reject message. As described above, this registration reject message is used when the FPLMN determines that a DRA exists between the FPLMN and both the “determined PLMN” and the HPLMN of the UE, but that the “determined PLMN” does not provide coverage in the current TA of the UE (i.e., the TA of the cell of the FPLMN).

In 620, the UE stores at least the tracking area identifier (TAI) of the cell from which the Cause 3 was received. The UE stores the TAI in a list that may include other parameters. In a first embodiment, the TAI is stored in a first list and associated with the FPLMN from which the registration rejection was received. In a second embodiment, the TAI is stored in a second list and associated with the “determined PLMN” that the UE included in the registration request. As described above, these lists may be erased periodically or upon the occurrence of certain events (e.g., switch-off of the UE or removal of the USIM).

In 625, if the UE remains in the same tracking area, the UE avoids re-attempting registration for disaster roaming using the same “determined PLMN”. In 630, the UE can attempt to register with the same FPLMN or with a further FPLMN offering disaster roaming using a different “determined PLMN.” The steps 610-625 can be performed again using the different “determined PLMN.” This process can continue until all “determined PLMNs” have been tried.

In 635, if the UE leaves the tracking area, the UE can attempt to register with the same FPLMN using the same “determined PLMN” as originally used in step 610. As described above in 615, the “determined PLMN” did not provide coverage in the original TA of the UE, but the “determined PLMN” may provide coverage in the new TA (and be under a disaster condition). In this scenario, the FPLMN will accept the registration request and provide disaster roaming services to the UE.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A processor of a user equipment (UE) configured to perform operations comprising:
receiving broadcast information from a cell of a public land mobile network (PLMN) including a parameter indicating support for disaster roaming, wherein the PLMN is a forbidden PLMN (FPLMN) for the UE;
attempting a registration with the FPLMN by sending a registration request to the PLMN including a PLMN ID of a determined PLMN under disaster;
receiving a message including a cause code indicating the disaster roaming for the FPLMN is not allowed in a current tracking area (TA) of the cell for the determined PLMN under disaster;
storing a tracking area identifier (TAI) of the cell; and
preventing further registration attempts with the FPLMN for the determined PLMN under disaster when the UE is in the current TA.

2. The processor of claim 1, wherein the operations further comprise:
attempting the registration with the FPLMN using the determined PLMN under disaster when the UE has moved to a new TA.

3. The processor of claim 1, wherein the TAI is stored in a list and is associated with the FPLMN.

4. The processor of claim 1, wherein the TAI is stored in a list and is associated with the determined PLMN under disaster.

5. The processor of claim 1, wherein the UE determines the determined PLMN under disaster based on information stored locally on the UE.

6. The processor of claim 1, wherein the determined PLMN under disaster is a home PLMN (HPLMN) of the UE only if the UE is located in a country of the HPLMN.

7. A user equipment (UE), comprising:
a transceiver configured to communicate with one or more networks; and
a processor communicatively coupled to the transceiver and configured to perform operations comprising:
receiving broadcast information from a cell of a public land mobile network (PLMN) including a parameter indicating support for disaster roaming, wherein the PLMN is a forbidden PLMN (FPLMN) for the UE;
attempting a registration with the FPLMN by sending a registration request to the PLMN including a PLMN ID of a determined PLMN under disaster;
receiving a message including a cause code indicating the disaster roaming for the FPLMN is not allowed in a current tracking area (TA) of the cell for the determined PLMN under disaster;
storing a tracking area identifier (TAI) of the cell; and
preventing further registration attempts with the FPLMN for the determined PLMN under disaster when the UE is in the current TA.

8. The UE of claim 7, wherein the operations further comprise:
attempting the registration with the FPLMN using the determined PLMN under disaster when the UE has moved to a new TA.

9. The UE of claim 7, wherein the TAI is stored in a list and is associated with the FPLMN.

10. The UE of claim 7, wherein the TAI is stored in a list and is associated with the determined PLMN under disaster.

11. The UE of claim 7, wherein the UE determines the determined PLMN under disaster based on information stored locally on the UE.

12. The UE of claim 7, wherein the determined PLMN under disaster is a home PLMN (HPLMN) of the UE only if the UE is located in a country of the HPLMN.

13. A processor of a base station configured to perform operations comprising:
transmitting broadcast information of a public land mobile network (PLMN) including a parameter indicating support for disaster roaming;
receiving a registration request from a user equipment (UE) including a PLMN ID of a determined PLMN under disaster, wherein the PLMN is a forbidden PLMN (FPLMN) for the UE;
determining that the determined PLMN under disaster does not provide coverage in a current tracking area (TA); and
transmitting a message including a cause code indicating the disaster roaming is not allowed by the FPLMN in the current TA for the determined PLMN under disaster.

14. The processor of claim 13, wherein the operations further comprise:
determining whether a first disaster roaming agreement (DRA) exists between the FPLMN and the determined PLMN.

15. The processor of claim 14, wherein the operations further comprise:
determining whether a second DRA exists between the FPLMN and a home PLMN (HPLMN) of the UE.

16. The processor of claim 15, wherein the cause code indicating the disaster roaming is not allowed by the FPLMN in the current TA is used only when the first DRA and the second DRA exist.

17. The processor of claim 13, wherein the determined PLMN under disaster is a home PLMN (HPLMN) of the UE only if the UE is located in a country of the HPLMN.
